(19) United States
(12) Patent Application Publication
(10) Pub. No.: US 2024/0094128 A1
(43) Pub. Date: Mar. 21, 2024

(54) METHOD, LIGHT MICROSCOPE, AND COMPUTER PROGRAM FOR LOCALIZING OR TRACKING EMITTERS IN A SAMPLE

(71) Applicant: Abberior Instruments GmbH, Goettingen (DE)

(72) Inventors: Roman SCHMIDT, Goettingen (DE); Andreas Schoenle, Goettingen (DE)

(21) Appl. No.: 18/240,147

(22) Filed: Aug. 30, 2023

(30) Foreign Application Priority Data
Sep. 15, 2022 (DE) 10 2022 123 632.3

(51) Int. Cl. G01N 21/64

(52) U.S. Cl. CPC G01N 21/6458

(57) ABSTRACT

Embodiments of the invention relates to a method for localizing or tracking emitters in a sample, wherein the sample is illuminated with an intensity distribution of an illumination light having a local minimum, wherein the illumination light induces or modulates light emissions of the emitters, and wherein the local minimum is positioned in a region around a presumed position of an emitter in the sample, detecting light emissions (L) of the emitter, and determining the position of the emitter in the sample, wherein light emanating from the sample is detected with a plurality of detector elements having respective active areas whose projections into a focal plane in the sample are not congruent, wherein a background is estimated based on the light detected by the plurality of detector elements, and wherein a background correction is performed, a light microscope and a computer program for performing the method.

### CROSS-REFERENCE TO RELATED APPLICATIONS

The present application claims the benefit of and priority to DE Patent Application Serial No. 10 2022 123 632.3, filed Sep. 15, 2022, the entire contents of which is incorporated herein by reference.

### TECHNICAL FIELD

The present disclosure relates to a method for localizing emitters or for tracking emitters Zo in a sample according to the MINFLUX principle, as well as to a light microscope and a computer program for carrying out the method.

### PRIOR ART

Under the term “MINFLUX microscopy” or “MINFLUX methods” certain localization and tracking methods for isolated emitters are summarized, in which a light distribution of illumination light, which induces or modulates light emissions of the emitter, is generated at the focus in the sample, the light distribution comprising a local minimum, and in which the position of an individual emitter is determined by detecting light emissions of the emitter, in particular taking advantage of the fact that the smaller the distance between the emitter and the minimum of the light distribution, the less light is emitted from the emitter. Due to the latter fact, MINFLUX methods are particularly photon efficient, particularly compared to so-called PALM/STORM localization methods. Additionally, in certain embodiments of the method, there is also the advantage that the emitters to be localized or tracked are exposed to relatively little light compared to other localization methods and are therefore less bleached.

The individual light-emitting emitters are, in particular, fluorophores and the illumination light is, in particular, excitation light which excites the fluorophores, whereupon they emit fluorescent light. Alternatively, the emitters may also be light-scattering particles, such as gold nanoparticles.

In particular, the light distribution with the local minimum may be 2D-donut-shaped or 3D-donut-shaped (bottle-beam-shaped).

A method of the type described above was described in patent application DE 10 2011 055 367 A1 for single molecule tracking. According to the method disclosed there, the position of a single fluorophore is tracked over time by tracking an excitation light distribution with a local minimum to the fluorophore such that the fluorescence emission rate is minimal.

In particular, patent application DE 10 2013 114 860 A1 describes a localization method in which the sample is scanned at grid points with the local minimum of an excitation light distribution to localize individual fluorophores.

The term “MINFLUX” is first used in the publication “Balzarotti F, Eilers Y, Gwosch K C, Zo Gynna A H, Westphal V, Stefani F D, Elf J, Hell S W. Nanometer resolution imaging and tracking of fluorescent molecules with minimal photon fluxes. Science. 2017 Feb. 10; 355(6325):606-612” is used. In the method described there, the MINFLUX principle is concretely implemented by first pre-localizing an individual fluorophore by scanning it with a first Gaussian-shaped excitation light distribution and then placing a second donut-shaped excitation light distribution at points that form a symmetric pattern of illumination positions around the fluorophore's position estimated in the pre-localization. The photon counts registered for each illumination position are then used to determine the position of the fluorophore to within a few nanometers using a maximum-likelihood estimator.

Further variants and embodiments of a MINFLUX localization system are described in patent applications DE 10 2016 119 262 A1, DE 10 2016 119 263 A1 and DE 10 2016 119 264 A1.

The publication “Gwosch K C, Pape J K, Balzarotti F, Hoess P, Ellenberg J, Ries J, Hell S W. MINFLUX nanoscopy delivers 3D multicolor nanometer resolution in cells. Nat Methods. 2020 February; 17(2):217-224” describes iterative 2D and 3D MINFLUX localization methods. Here, the sample is illuminated in several iteration steps at illumination positions with the minimum of a donut-shaped excitation light distribution, wherein the illumination positions form a symmetric illumination pattern centered around the position of the fluorophore estimated in each previous step, and wherein the illumination positions are placed closer around the currently estimated position of the fluorophore in each iteration step. This allows very high positional accuracy to be achieved in a few steps.

Another iterative MINFLUX localization and tracking method using a modified position estimator and based on a commercial microscope setup is described in “Schmidt R, Weihs T, Wurm C A, Jansen I, Rehman J, Sahl S J, Hell S W. MINFLUX nanometer-scale 3D imaging and microsecond-range tracking on a common fluorescence microscope. Nat Commun. 2021 Mar. 5, 12(1):1478”.

The light that induces or modulates the light emission of the emitters may also be STED (stimulated emission depletion) light, for example. For example, patent applications DE 10 2017 104 736 A1 and EP 3 372 989 A1 describe MINFLUX-like methods based on superposition of an excitation light distribution with local maximum with a STED light distribution with local minimum. The sample is scanned by shifting the STED distribution with the STED minimum and the position of the fluorophore is determined from the measured values of fluorescence intensity at different positions of the STED intensity distribution. Here, in contrast to the MINFLUX methods described previously, the fluorophore emits more light with decreasing distance from the local minimum. Such methods are also referred to as “STED-MINFLUX methods”.

Patent application WO 2020/128106 A1 and the publication “Masullo L A, Steiner F, Za\ddot{h}ringer J, Lopez L F, Bohlen J, Richter L, Cole F, Tinnefeld P, Stefani F D. Pulsed Interleaved MINFLUX. Nano Letters 2021, 21 (1), 840-846” describe, among other things, embodiments of MINFLUX localization methods in which the positions at which the sample is illuminated with the minimum of the excitation light distribution are fixed by arrays of optical fibers, wherein the excitation light is generated by a pulsed laser, and wherein individual excitation light pulses are output with a time delay through the different fiber ends of the optical fibers.

The publication “Masullo L A, Lopez L F, Stefani F D. A common framework for single-molecule localization using sequential structured illumination. Biophysical Reports 2022 2(1), 100036” describes a variant of the MINFLUX technique, referred to as RASTMIN, in which a small area within a microscopic field of view containing a single emitter is scanned in a Cartesian grid with the minimum of a donut-shaped excitation light distribution, and the position of the emitter is determined from the detected light intensities.

In the publication “Slenders E, Vicidomini G. ISM-FLUX: single-step MINFLUX with an array detector. bioRxiv; 2022. DOI: 10.1101/2022.04.19.488747”, a MINFLUX method is described in which the light emitted from a single fluorophore is detected in a position-dependent manner using an array detector to determine the position of the fluorophore in a single localization step non-iteratively, without repositioning the illumination pattern and without pre-localization.

The publication “Brakemann, T., Stiel, A., Weber, G. et al. A reversibly photoswitchable GFP-like protein with fluorescence excitation decoupled from switching. Nat Biotechnol 29, 942-947 (2011). https://doi.org/10.1038/nbt.1952” describes a fluorescence emitter (a variant of green fluorescent protein) that can be excited, activated, and reversibly inactivated by irradiation with light of three different wavelengths.

Patent application EP 3 951 470 A1 discloses a method for adapting a position estimator for a MINFLUX method. In this method, fluorescence photons emitted from the sample are detected and summed up. A value representing background light is determined from the obtained sums for sets of illumination positions where no emissions occur. A position estimator is then corrected for the position of individual emitters in the sample using an expected value for the background determined from measurements. Thus, a background value is continuously determined during the MINFLUX measurement or during the detection of fluorophores in the sample. The sums of photon numbers are added to a so-called running histogram, where, for example, the background value can be determined from the maximum of the histogram. Preferably, a least-mean-square position estimator (LMSE) is used in this method, and an illumination pattern is used whose illumination positions are symmetrically arranged around an expected position of a single emitter, with no illumination position in the center (at the expected position) being used for position estimation. The term in the numerator of the uncalibrated estimator is not affected by background light distributed homogeneously in the sample, because the contributions of background light balance each other due to the symmetry of the illumination positions. In contrast, the background light directly affects the total sum of the detected photon numbers, which is in the denominator of the position estimator. Therefore, without background correction, the position estimator exhibits a systematic deviation to the center of the illumination pattern. The position estimator can now be easily corrected using the method disclosed in EP 3 951 470 A1 by subtracting a background value currently determined from the running histogram for each illumination step from the sum of the photons detected over all illumination positions in that step. In addition, the position estimator can be calibrated, e.g. based on a correction polynomial whose parameters have been determined with a simulation.

Although the described method provides satisfactory background correction, especially for temporally fluctuating background, it is not capable of correcting measurement errors caused by background emissions distributed inhomogeneously in the sample. Furthermore, the expected value determined via the running histogram can have a relatively large error if not enough measured values are available for the background.

Objective

Therefore, it is the objective of the present disclosure to improve the background correction for a MINFLUX method, particularly with respect to the disadvantages of the prior art discussed above.

### Solution

This objective is attained by the subject matter of claims 1, 19 and 20. Advantageous embodiments are indicated in subclaims 2 to 18 and are described below.

### DESCRIPTION

A first aspect of the present disclosure relates to a method for localizing or tracking emitters in a sample, comprising the steps of
performing an illumination sequence with a plurality of illumination steps, wherein the sample is illuminated in the illumination steps in each case with an intensity distribution of an illumination light comprising a local minimum, such that illumination positions in the sample are illuminated with different light intensities of the illumination light in the illumination steps, wherein the illumination light induces or modulates light emissions of the emitters, and wherein the local minimum of the intensity distribution is positioned in a region around a presumed position of an emitter in the sample in the illumination steps,
detecting light emissions of the emitter for the respective illumination steps and
determining the position of the emitter in the sample from the light emissions detected for the respective illumination steps.

According to the present disclosure, light emanating from the sample is detected with a plurality of detector elements, the detector elements comprising respective active areas whose projections into a focal plane in the sample are not congruent, wherein a background is estimated based on the light detected with the plurality of detector elements, and wherein a background correction is performed in determining the position of the emitter or for the determined position of the emitter based on the estimated background.

In particular, one or more values representing the background are determined based on the light detected by the plurality of detector elements, and the background correction is performed based on the value or values representing the background.

The plurality of detector elements are able to detect the light coming from the sample in a position-dependent manner. In this way, the signal of interest (the light emissions from the emitter to be localized or tracked) can be better separated from background light. Depending on the specific embodiment, it is also possible to detect inhomogeneously distributed background so that, for example, different values representing the background may be determined for different illumination positions/illumination steps. Both lead to an improved background correction and thus to a better position estimation.

Finally, in situations where emitter emissions are not expected, for example, more background photons can be collected per unit time using multiple detector elements in parallel. For example, a running histogram of background photon counts can be constructed more quickly, and a meaningful expected value for the background can be determined more quickly. Another advantage is that the light emissions from the emitter and the background light can be detected in parallel, whereas in the prior art the background could only be reliably measured at times when the emitters in the area of the sample under investigation are in a dark state or when there are no emitters in this area.

As explained above, at least two detector elements are provided according to the present disclosure, which have active areas whose projections through an optical system (in particular objective lens and further lenses of a light microscope as well as at least one pinhole) into the sample are not congruent. That is, the respective projection areas may be disjoint or overlapping, but not completely congruent. In this context, the term “active area” refers to an area of the detector that provides a signal when light strikes the area. Of course, said projections are not identical with actual images of the active areas by the optical system, wherein of course particularly diffraction has to be considered.

For example, spectral detection units having multiple detectors associated with a common pinhole or associated with respective pinholes having the same aperture diameter, are expressly not within the scope of the claims because their active areas have congruent projections into the sample.

In the context of the present disclosure, the term “pinhole” refers to an optical component having a central region that transmits light and a region surrounding the central region that does not transmit light. The central region may be on opening/aperture. Alternatively, the central region may comprise a material that is at least partially translucent.

The plurality of detector elements may, for example, belong to a camera with pixels that can detect and register single photons, or to a so-called array detector, e.g., a SPAD (single photon avalanche photodiode) array. By an array detector is meant here a two-dimensional arrangement of detector elements, whereby the detector elements can be read out individually (and in particular not line by line as in a camera). In particular, the detector elements are capable of detecting and registering individual photons.

Alternatively, the plurality of detector elements may also be multiple point detectors that are not arranged in a plane as long as their active surfaces are not projected congruently into the sample by the optical system of the light microscope used for the method. For example, it is conceivable to capture the detection light simultaneously with two or more point detectors to which pinhole apertures of different widths are assigned.

The term “emitter” refers to molecules, molecular complexes or particles that emit light when illuminated with the illumination light. The emitted light may be, in particular, fluorescent light, Rayleigh scattered light or Raman scattered light. In this context, in particular, an emitter can be regarded as a point light source in the case of diffraction-limited imaging with a light microscope, and thus in particular has an extent in the range of the diffraction limit of light microscopy or below. The emitters may be, for example, single fluorophores (fluorescent dyes), molecules or molecular complexes labeled with one or more fluorophores, or so-called quantum dots. The fluorescent dyes may be bound to the molecules by covalent or non-covalent interactions. Biological macromolecules such as proteins, for example, are often detected by binding to antibodies, which in turn are covalently linked to fluorescent dyes. Furthermore, an emitter in the sense of the present disclosure may also be, for example, a light-scattering nanoparticle, such as a gold nanoparticle.

In the context of the present application, a “localization” is understood to be a method in which a position (in one to three dimensions) of an emitter in a sample is determined, the emitter being substantially stationary in the sample, particularly on the time scale of the experiment. During localization, the emitter may of course move relative to a reference frame given by the objective, for example by drift, which can be compensated for by known compensation methods. In particular, the position of the emitter is used to determine the position of a molecule, molecular complex, or particle labeled with the emitter during localization. In the practice of localization microscopy, several emitters are usually localized in the sample one after the other and an image of structures in the sample is calculated from the individual localizations.

In contrast, “tracking” an emitter is the determination of multiple positions of the emitter over time, wherein in particular the emitter moves relative to other sample structures. This method, also known as “tracking,” can be used, for example, to create trajectories of individual molecules labeled with fluorescent dyes. In this way, in particular, dynamic processes can be studied.

The illumination sequence comprises several illumination steps, in each of which the minimum of the intensity distribution of the illumination light is arranged at different positions in a region around the presumed position of the first emitter, or in which different intensity distributions are arranged at the same position or at different positions in said region. In both cases, certain positions in the sample are exposed to different light intensities, in particular along an intensity gradient. From at least two measurements of the light emissions and the known positions and gradients of the intensity distribution or distributions, a presumed position of an emitter can then be calculated using a position estimator.

According to one embodiment, the local minimum of the intensity distribution in the illumination sequence is positioned, in particular successively, at illumination positions forming an illumination pattern, wherein the illumination positions of the illumination pattern are arranged in a region around the presumed position of the at least one emitter, in particular wherein the illumination positions are arranged on a scanning circle or scanning sphere around the presumed position or the illumination pattern is a grid of illumination positions.

According to a further embodiment, the illumination sequence comprises sequentially illuminating the sample with at least two different intensity distributions.

Since an intensity distribution with a local minimum is used for localizing or tracking the emitters, the method according to the present disclosure is in particular a so-called MINFLUX method. The illumination light may be excitation light which induces the light emissions of the emitters, where in particular the light emissions of the emitters are fluorescence emissions which occur due to excitation of the emitters with the excitation light. This method then takes advantage of the fact that the smaller the distance of an individual emitter from the local minimum of the intensity distribution of the excitation light, the smaller the light emissions of that emitter. In particular, this has the advantage of a particularly high information content of the light emissions. Alternatively, light that modulates the light emissions, e.g., STED (stimulated emission depletion) light or inactivation light, may also be used as illumination light in the MINFLUX process. This is then combined with focused excitation light. In this case, the light emissions induced by the excitation light depend on the distance of the actual emitter position from the local minimum of the light modulating the light emissions such that the smaller this distance, the more light emissions occur. Such STED MINFLUX methods also belong to the MINFLUX methods or methods according to the MINFLUX principle in the sense of the present disclosure.

The intensity distribution of the illumination light comprises intensity increasing areas along at least one direction adjacent to the, in particular central, local minimum, which is ideally an intensity zero. In particular, the local minimum is surrounded by intensity increasing areas along two directions in a focal plane perpendicular to the direction of propagation of the illumination light. Such a light distribution is, for example, a so-called donut (or 2D donut), which can be obtained, for example, by phase modulating a light beam with a vortex-shaped (helical) phase distribution. The local minimum may also be surrounded by intensity increasing areas in three spatial directions, i.e., in particular, in addition to the directions in the focal plane along an axial direction parallel to the direction of propagation of the illumination light. An example of such a light distribution is a so-called bottle beam or 3D donut, which can be generated by phase modulation through a phase distribution with an annular phase shift of p. Intensity distributions are also known which have only intensity increasing areas along one spatial direction. The local intensity minimum of such distributions can, for example, be extended in a plane, with the intensity increasing perpendicular to this plane. Such distributions may be generated in particular by phase modulation with a phase pattern that comprises a phase jump of p extending along a line. Regardless of the direction of the increasing area, the steeper the intensity gradient in the increasing area, the more information can be obtained about the position of an emitter.

In order to obtain the initial presumed position of the emitter and the corresponding region in which the local minimum of the intensity distribution is positioned in the first illumination step, a pre-localization step based on an independent localization method is performed in particular. In this case, the initial presumed position can be performed with much lower accuracy than the MINFLUX localization. For example, a pre-localization method is known from the prior art in which a Gaussian focus of illumination light is placed at different positions in the sample, light emissions are detected, and the initial position is estimated from this. Furthermore, a pre-localization method is known in which a so-called pinhole orbit scan is performed with an intensity distribution of the illumination light with a local minimum. In this method, a pinhole is arranged in front of the detector, the image of which is shifted in a circular path in the sample by controlling two beam displacement units, while the illumination light beam remains stationary relative to the sample. A first beam displacement unit (in particular a galvo scanner) is arranged in the common illumination and detection beam path, while a second beam displacement unit (in particular two electro-optical deflectors arranged in series) is positioned only in the illumination beam path, but not in the detection beam path. The first beam displacement unit displaces the image of the detector pinhole in the sample, while the second beam displacement unit compensates for the resulting displacement of the illumination light beam. The same localization principle can be realized by detecting the light emissions of the sample illuminated by a stationary intensity distribution positions dependent in a detection plane, e.g. with an array detector.

The MINFLUX or STED MINFLUX method according to the present disclosure may in particular be carried out iteratively. That is, the illumination sequence is performed in several iterations, with the position of the emitter being determined at the end of an iteration. In the subsequent iteration, the local minimum of the intensity distribution is then arranged in a region around the position determined in the previous iteration, in particular with changed parameters. For example, the diameter of an illumination pattern of illumination positions where the local minimum is positioned in the illumination sequence may be reduced in each iteration compared to the previous iteration. In particular, the total intensity of the illumination light is increased. In this way, the position determination in the iterations is performed with increasingly higher accuracy.

According to one embodiment, the plurality of detector elements comprise at least one first detector element and at least one second detector element, wherein a value representing light emissions from the emitter is determined based on light detected with the at least one first detector element, and wherein a value representing background is determined based on light detected by the at least one second detector element.

In particular, the first detector element detects light from an area of the sample from which light emissions from the emitter originate with a higher probability than from the area from which the second detector element detects light.

For example, a first confocal pinhole may be assigned to the first detector element and a second confocal pinhole to the second detector element, wherein the first confocal pinhole and the second confocal pinhole comprise different aperture diameters. In this way, an improvement of the background correction may already be achieved in a very simple way.

Alternatively, for example, the detector elements of an array detector or camera may be divided into groups of first detector elements and second detector elements, wherein the light emissions detected by the groups of detector elements are evaluated separately. Of course, the detector elements may also be divided into further groups or certain groups may be divided into subgroups.

According to a further embodiment, a plurality of second detector elements are provided, in particular wherein a plurality of first detector elements are also provided.

According to a further embodiment, a location-dependent background light distribution is determined from the light detected by the plurality of detector elements, wherein the background correction is performed depending on the respective position of the local minimum of the intensity distribution by means of respective associated values of the background light distribution.

This has the advantage that inhomogeneously distributed background in the sample can be specifically taken into account in the background correction, which can significantly improve the quality of position determination under such conditions.

According to a further embodiment, respective values representing the background are determined for the illumination steps based on the detected background light, the background correction being carried out by means of the values representing the background. That is, respective (specific) values representing the background are determined for certain illumination positions or illumination steps or groups of illumination positions or illumination steps, in particular based on the determined background light distribution, wherein the light emissions detected for the respective illumination positions/illumination steps are corrected with the aid of the respective values representing the background.

According to a further embodiment, the plurality of detector elements are arranged in a detection plane. In particular, the detection plane is an image plane with respect to the focal plane in the sample. This is the case, for example, with area detectors such as cameras and array detectors. This has the advantage that, due to the location-dependent detection, more information can be collected about the background, which is used in the background correction. For example, depending on the size of the area mapped onto the detection plane, interfering background light from areas below and above the focal plane is also detected and separated from the light from the focal plane. In particular, inhomogeneously distributed background can additionally be detected and corrected.

According to a further embodiment, the at least one first detector element covers a first contiguous partial area of the detection plane, wherein the second detector elements cover a second contiguous partial area of the detection plane. In particular, the first partial area and the second partial area are disjoint. However, they may alternatively partially overlap.

According to a further embodiment, the second partial area encloses the first partial area.

According to a further embodiment, the first partial area covers a central circular area of the detection plane. In particular, the second partial area covers an annular region of the detection plane arranged around the central circular region. Depending on the number, size, shape, and arrangement of the detector elements (e.g., Cartesian or hexagonal), the detector elements approximate the partial areas more or less accurately. For example, with relatively few detector elements arranged on a Cartesian grid, the central circular area can be covered by a square first partial area. Since a large portion of the background light originates from areas above and below the focal plane in the sample, the second (outer) partial area receives proportionally more background light than the first partial area in this embodiment, which can advantageously be used to determine the value representing the background.

According to a further embodiment, the first partial area or central circular area in the detection plane has an extent of 0.5 Airy Units to 1.0 Airy Units. Accordingly, the first detector elements mainly receive light from the focal plane, while the second detector elements, when arranged around the first partial area, mainly detect light from the planes above and below the focal plane, which contains proportionally more background light.

According to a further embodiment, light emanating from the sample reaches the at least one first detector element through a pinhole, wherein the pinhole comprises a reflective surface, and wherein the at least one second detector element is arranged on a side of the pinhole opposite the at least one first detector element, so that light reflected from the reflective surface is detected by the at least one second detector element. In particular, the pinhole is arranged in an image plane with respect to the focal plane. In particular, the reflecting surface is arranged at an angle of less than 90° with respect to an optical axis along which the (detection) light emanating from the sample propagates toward the pinhole, i.e., the reflecting surface is not perpendicular to the optical axis. In this way, the reflected light can be easily directed to the second detector element. In particular, the first detector element and the second detector element are each formed by separate point detectors.

This embodiment has the advantage that background light from areas above and below the focal plane can be measured in a very simple way to perform background correction.

According to a further embodiment, the pinhole comprises a central light-transmitting region, in particular an aperture, with an extent of 0.5 Airy Units to 1.0 Airy Units. This ensures that the light detected by the first detector element comes to a large extent from the focal plane, while the reflected light detected by the second detector element comes mainly from areas above and below the focal plane and is therefore rather background light.

According to a further embodiment, a weighted sum or difference is formed between intensities or photon counts of the light detected by the at least one first detector element and the light detected by the at least one second detector element, wherein the position of the emitter and/or the value representing the background is determined based on the weighted sum or difference. Here, it is taken into account that the first and the second detector elements detect both light emissions from the emitter and background light, but to a different extent depending on their arrangement. In the simplest case, for example, the difference w₁p₁−w₂p₂ may be formed, wherein w₁ and w₂ are weights between 0 and 1, wherein w₁+w₂=1 holds, and wherein p₁ and p₂ denote the photons detected by the at least one first detector element and the at least one second detector element, respectively. The difference obtained may then be used, for example, instead of the value pⱼ in the uncalibrated LMS estimator known from the prior art in the form of the vector sum

$$u ( {p}_{j} , {b}_{j} ) = \frac{{\sum }_{j = 1}^{m} {p}_{j} {b}_{j}}{{\sum }_{j = 1}^{m} {p}_{j}} .$$

This difference formation is then already the background correction according to the present disclosure.

Alternatively, the value representing the background may be determined e.g. from a weighted sum w₁p₁+w₂p₂ of the light detected by the at least one first and the at least one second detector element, which is then subtracted, for example, from the sum in the denominator and/or the individual summands in the numerator of the uncalibrated LMS estimator

$$u ( {p}_{j} , {b}_{j} ) = \frac{{\sum }_{j = 1}^{m} {p}_{j} {b}_{j}}{{\sum }_{j = 1}^{m} {p}_{j}}$$

in order to perform the background correction.

According to a further embodiment, the background is estimated in parallel with the determination of the position of the emitter, in particular wherein the value representing the background is determined in parallel with the determination of the position of the emitter. That is, the determination of the position of the emitter and the determination of the background are performed simultaneously or alternating with each other during the illumination sequence. This has the particular advantage that no additional time is required for an initial determination of the background, which speeds up the method.

According to a further embodiment, light is detected with the plurality of detector elements before performing the illumination sequence, and the background is estimated from the detected light. In this way, the measurement conditions can be optimally matched to the background detection, which increases the quality of the background correction.

A second aspect of the present disclosure relates to a light microscope, in particular configured for performing the method according to the first aspect, comprising
a light source configured to generate illumination light that induces or modulates light emissions from an emitter in a sample,
a light modulator configured to generate an intensity distribution of the illumination light with a local minimum in the sample,
a control unit which is configured to perform an illumination sequence with a plurality of illumination steps, the control unit being configured to control the light source and/or the light modulator in such a way that the sample is illuminated in each case with an intensity distribution of the illumination light comprising a local minimum in the illumination steps, such that illumination positions in the sample are illuminated with different light intensities of the illumination light in the illumination steps, and such that the local minimum of the intensity distribution is positioned in a region around a presumed position of an emitter in the sample in the illumination steps,
at least one detector configured to detect light emanating from the sample for the illumination steps, and
a computing unit configured to determine the position of the emitter in the sample from the light emissions detected for the respective illumination steps.

According to the present disclosure, the at least one detector comprises a plurality of detector elements, the detector elements comprising respective active areas whose projections into a focal plane in the sample are not congruent, wherein the computing unit is configured to estimate a background based on the light detected by the plurality of detector elements and to perform a background correction based on the estimated background in determining the position of the emitter or for the determined position of the emitter.

According to one embodiment, the detector is an array detector having a plurality of individually readable detector elements arranged in a detection plane.

According to a further embodiment, the detector elements of the detector comprise at least one first detector element and at least one second detector element, wherein the computing unit is configured to determine a value representing the light emissions of the emitter based on the light detected with the at least one first detector element and to determine a value representing the background based on the light detected with the at least one second detector element.

According to a further embodiment, the detector comprises a plurality of first detector elements and a plurality of second detector elements.

According to a further embodiment, the computing unit is configured to determine a location-dependent background light distribution from the light detected by the plurality of detector elements, wherein the computing unit is configured to perform the background correction depending on the respective position of the minimum of the intensity distribution by means of respective associated values of the background light distribution.

According to a further embodiment, the computing unit is configured to determine respective values representing the background for the illumination steps based on the detected background light and to perform the background correction using the values representing the background.

According to a further embodiment, the light microscope comprises a first detector comprising the first detector element, a second detector comprising the second detector element, a first pinhole upstream of the first detector element, a pinhole associated with the second detector element, and a beam splitter, wherein the beam splitter is configured to split light emanating from the sample into a first partial beam path and a second partial beam path, wherein the first partial beam path comprises the first pinhole and the first detector, and wherein the second partial beam path comprises the second pinhole, the first pinhole and the second pinhole comprising light-transmitting central regions, in particular apertures, of different extent.

According to a further embodiment, the light microscope comprises a pinhole comprising a reflective surface, wherein the at least one second detector element is arranged on a side of the pinhole opposite to the at least one first detector element, such that light reflected from the reflective surface is detected by the at least one second detector element. In particular, the pinhole is arranged in an image plane with respect to a focal plane in the sample. In particular, the reflective surface is arranged at an angle of less than 90° with respect to an optical axis along which the (detection) light emanating from the sample propagates towards the pinhole. In particular, the pinhole has a light-transmitting central region, particularly an aperture, with an extent of 0.5 Airy Units to 1.0 Airy Units.

According to a further embodiment, the computing unit is configured to form a weighted sum or a weighted difference between intensities or photon counts of the light detected by the at least one first detector element and the light detected by the at least one second detector element and to determine the position of the emitter and/or the value representing the background based on the weighted sum or difference.

According to a further embodiment, the computing unit is configured to determine the value representing the background in parallel with the determination of the position of the emitter.

According to a further embodiment, the control unit is configured to control the plurality of detector elements such that the detector elements detect light prior to performing the illumination sequence, wherein the computing unit is configured to estimate the background from the detected light.

A third aspect of the present disclosure relates to a computer program comprising instructions that cause the light microscope according to the second aspect to perform the method according to the first aspect.

Further features of the light microscope according to the second aspect and of the computer program according to the third aspect result from the features of the method according to the first aspect described above.

Advantageous further embodiments of the present disclosure result from the claims, the description and the drawings and the associated explanations to the drawings. The described advantages of features and/or combinations of features of the disclosure are merely exemplary and may have an alternative or cumulative effect.

In the following, embodiments of the present disclosure are described with reference to the figures. These do not limit the subject matter of this disclosure and the scope of protection.

### BRIEF DESCRIPTION OF THE FIGURES

FIG. 1 shows a light microscope according to a first embodiment with an array detector;

FIG. 2 shows a light microscope according to a second embodiment with two point detectors;

FIG. 3 shows a detection beam path of a light microscope according to a third embodiment with a mirrored pinhole aperture and two point detectors.

### DESCRIPTION OF THE FIGURES

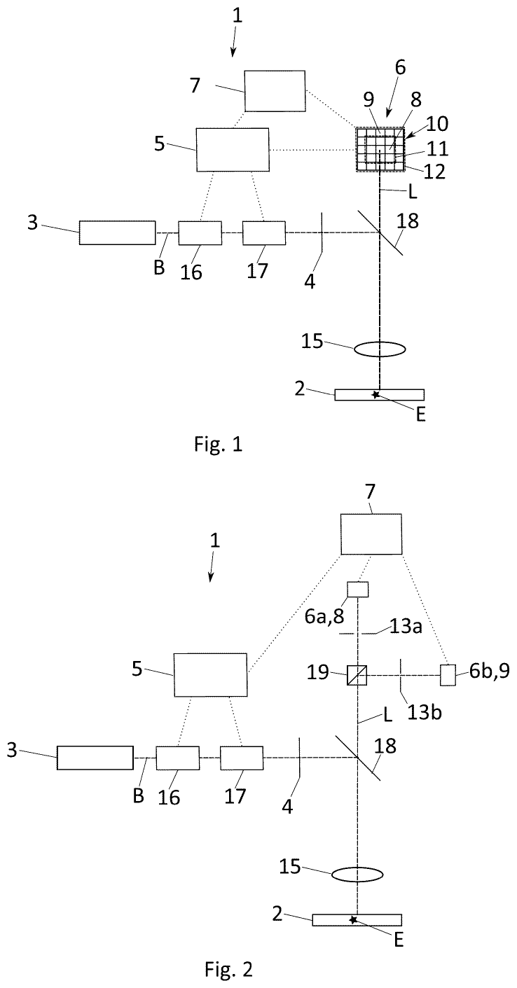

FIG. 1 shows a first embodiment of a light microscope 1 according to the present disclosure, which is configured to carry out a localization or tracking process according to the MINFLUX principle. The light microscope 1 comprises a light source 3, e.g., a laser, for generating illumination light B, in particular excitation light, which excites emitters E in the sample 2 to luminescence, in particular fluorescence. The illumination light B is modulated in its phase and/or amplitude by a light modulator 4, so that at the focus in the sample 2, which is formed by focusing the illumination light B with the objective lens 15, a light distribution of the illumination light B with a local minimum, e.g., a so-called donut or bottle beam, is formed. Instead of the transmissive light modulator 4 (such as a phase plate) shown as an example in FIG. 1, it is of course also possible to use a light modulator 4 with a reflective or light diffracting active surface, for example a liquid crystal modulator with a blaze grating and programmable pixels (also known as a spatial light modulator).

The light beam of the illumination light B is deflected by a first beam displacement device 16 and a second beam displacement device 17 in two directions perpendicular to the direction of propagation of the illumination light B. The deflected light beam reaches the objective lens 15 via the first beam splitter 18. The deflected light beam passes through the first beam splitter 18 to the objective lens 15, which focuses the light beam into the sample 2. In particular, the first beam displacement device 16 and the second beam displacement device 17 are electro-optical deflectors. The first beam displacement device 16 and the second beam displacement device 17 are connected to a control unit 5 that controls the beam displacement devices 16,17 to shift the focus of the illumination light B laterally in the sample 2.

In addition to the beam displacement devices 16,17, the light microscope 1 may comprise further beam or sample displacement devices. For example, in particular between the beam splitter 18 and the objective lens 15, a galvo scanner may be arranged to perform a lateral coarse positioning of the light beam of the illumination light B with respect to the sample 2 and to center the field of view on the currently estimated position of the emitter E, e.g., in iterative MINFLUX procedures.

As an alternative to the beam displacement devices 16,17, a fiber optic having a plurality of fiber bundles may be provided, for example, wherein the illumination light B is selectively coupled into respective fibers of the fiber bundle to illuminate specific regions of the sample 2 with the illumination light B (not shown).

For shifting the illumination light focus in the axial direction (parallel to the propagation direction of the illumination light beam), a deformable mirror may additionally be provided, for example (not shown).

In particular, the emitter E is individual in the sample 2, i.e., it has a distance from other actively emitting emitters that corresponds at least to Abbe's diffraction limit or it can be distinguished from other closer neighboring emitters by the light it emits, e.g. spectrally or due to its fluorescence lifetime.

The light emissions L emanating from the emitter E in the sample 2 pass through the objective lens 15 and the first beam splitter 18, which is in particular a dichroic mirror, to a detector 6 for detecting the light emissions L. According to the example shown in FIG. 1, the detector 6 is configured as an array detector (e.g., SPAD array) with several detector elements 8, 9 which can be read independently of one another and count single photons and which are arranged in a detection plane 10. FIG. 1 shows an example of an array detector with detector elements 8,9 arranged on a Cartesian grid. However, other arrangements are of course also possible, e.g., a hexagonal arrangement. The detection plane 10 is in particular a confocal plane with respect to the focal plane in the sample, i.e., an image plane with respect to the focal plane.

The detector elements 8,9 of the detector 6 are divided into first detector elements 8 and second detector elements 9, the first detector elements 8 forming a central first partial area 11 of the detector 6 in the detection plane 10 and the second detector elements 9 forming a second partial area 12 of the detector 6 enclosing the first partial area 11. In particular, the first partial area 11 has an extent of 0.5 to 1.0 airy units. In FIG. 1, an example with a total of 25 detector elements is shown, wherein the central nine first detector elements 8 form the first partial area 11 and the outer 16 second detector elements 9 form the second partial area 12.

Thus, projections of the first detector elements 8 and the second detector elements 9 into the sample 2 are not congruent, and the first detector elements 8 and the second detector elements 9 receive and consequently detect different portions of the light emanating from the sample 2. In particular, the first detector elements 8 thereby receive more light emanating from the emitter E in the sample 2 and the second detector elements 9 receive more interfering background light, so that in a simple embodiment of the method according to the present disclosure, the light detected by the second detector elements 9 can be used as a measure of the background.

In fact, however, the first detector elements 8 and the second detector elements 9 receive both the light of the light emissions L of interest from the emitter E (signal) and background light, but in different proportions. Therefore, in particular, the background can also be estimated from a weighted difference of the light detected by the first detector elements 8 and second detector elements 9 according to the present disclosure.

Additionally or alternatively, the distribution of the detected light intensities/photons on the detector elements 8,9 of the array can be analyzed to estimate the background.

According to the present disclosure, the detector elements 8,9 may also be divided into more than two groups. In this case, for example, the light detected by a respective group of the detector elements 8,9 may be used to determine a value representing the background for a respective illumination position (i.e., a position of the minimum of the intensity distribution of the illumination light). This is particularly advantageous when inhomogeneously distributed background light occurs.

Finally, the light microscope 1 comprises a computing unit 7 coupled to the detector 6 for determining the position of the emitter E in the sample 2 from the detected light emissions L. In particular, the computing unit 7 also estimates the background from the light detected with the detector elements 8,9 and subsequently performs a background correction which is taken into account in the position determination.

The computing unit 7 may be formed separately from the control unit 5, as shown as an Zo example in FIG. 1. Alternatively, however, a single processor may perform the function of the control unit 5 and the computing unit 7. This may be, for example, a so-called field-programmable gate array (FPGA), an application-specific integrated circuit (ASIC) or a microcontroller.

FIG. 2 shows a further embodiment of the light microscope 1 according to the present disclosure, which comprises an identical illumination beam path as the light microscope 1 according to FIG. 1 (identical components are designated with identical reference signs), but comprises two point detectors 6a,6b instead of the array detector.

After passing through the first beam splitter 18, the detection light is split by a second beam splitter 19 into two sub-branches of the detection beam path. The second beam splitter 19 may be a neutral beam splitter, for example a 50/50 beam splitter or a 70/30 beam splitter. The first detector 6a is preceded by a first confocal pinhole 13a and the second detector 6b is preceded by a second confocal pinhole 13b, wherein the pinholes 13a,13b have apertures with different aperture diameters so that projections of the active areas of the point detectors 6a,6b into the sample 2 are not congruent. Thus, the detectors 6a,6b detect light from different regions of the sample 2 so that, for example, the first detector 6a can be used as the first detector element 8 and the second detector 6b can be used as the second detector element 9 to distinguish the light emissions L from the emitter E from the background and to perform background correction. For example, the light detected by the first detector element 8 may be associated with the light emissions L of the emitter E, while a value representing the background is determined from the light detected by the second detector element 9. Alternatively, a value representing the background may be determined from a weighted sum of the photons or light intensities detected by the first detector element 8 and the second detector element 9.

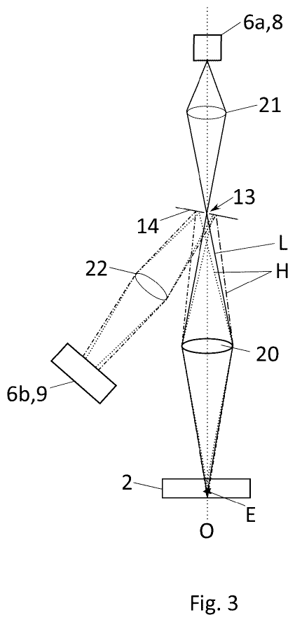

FIG. 3 shows the detection beam path of a further light microscope 1 according to the present disclosure, which may be constructed with respect to its other components in the same way as the light microscope 1 shown in FIG. 1. The light emerging from the sample 2 and propagating in the direction of an optical axis O is focused onto a pinhole 13 by a first lens 20 or a lens system, which may in particular comprise the objective lens 15, a tube lens and optionally further lenses. The pinhole 13 is thus in an image plane with respect to the focal plane. The pinhole 13 comprises a reflective surface 14, wherein the reflective surface 14 is tilted relative to the optical axis O, i.e., has an angle of less than 90° to the optical axis O.

Light emissions L emanating from the emitter E located in the focal plane pass through the pinhole 13 and are focused by a second lens 21 onto a first detector 6a, e.g., a point detector.

In contrast, background light from planes above and below the focal plane, which is thus not focused by the lens 20 on the pinhole 13, is deflected toward a third lens 22 which focuses the light on a second detector 6b, e.g., another point detector.

Thus, the active areas of the first detector 6a and the second detector 6b do not have congruent projections into the sample 2.

In particular, the first detector 6a acts as a first detector element 8 that detects light emissions L from the emitter E, while the second detector 6b acts as a second detector element 9, wherein a value representing the background is determined from the light detected by the second detector element 9, which is used to perform the background correction.

The following describes a MINFLUX method that can be performed with the light microscopes 1 shown in FIGS. 1-3.

In order to localize or track an individual emitter E in the sample 2, in particular a pre-localization is first performed, in which the emitter E is found in the sample 2 and an initial position of the emitter E is determined with lower accuracy. For this purpose, the sample may be impinged, for example, on points of a grid, with the intensity distribution of the illumination light B with the local minimum or with a regular, Gaussian focus, the light emissions L of the emitter E may be detected with the detector 6 and the approximate position of the emitter E may be determined from the detected light intensities or photon numbers with the computing unit 7.

In the embodiment according to FIG. 1, the light intensities are detected in particular in a position-dependent manner in the detection plane 10 with the array detector 6. With the light microscope according to FIG. 2 or 3, on the other hand, so-called pinhole orbit scanning may be used for pre-localization. For this purpose, an additional galvo scanner may be provided in the common excitation and detection beam path. In pinhole orbit scanning, the control unit 5 controls the galvo scanner and the beam displacement devices 16,17 (in particular EODs) in such a way that the intensity distribution of the illumination light B with the local minimum remains stationary relative to the sample 2 while the image of the pinhole 13 or 13a or 13b into the sample 2 is moved along a circular path. The position of the emitter E can then be estimated from the photons detected for different positions on the circular path.

After the pre-localization, in particular an iterative MINFLUX process is carried out. In a first iteration step, the control unit 5 performs an illumination sequence in which the local minimum of the intensity distribution of the illumination light B is successively placed in several illumination steps at respective illumination positions arranged around the initial position of the emitter E estimated in the pre-localization. For example, a symmetrical illumination pattern can be used in which the illumination positions are arranged at the corners of an imaginary hexagon, with the estimated position at the center of the hexagon. For each illumination position, the light emissions L detected by the detector 6 are determined. Therein, each illumination position may be steered to once or several times, i.e., the illumination steps may be performed once or several times within one iteration.

In the case where the detector 6 is an array detector, the light emissions L used for position determination may be the sum of the light emissions L detected by all detector elements 8,9, for example, or only the light emissions L detected by the first detector elements 8 may be used, for example.

From the detected light emissions L, the position of the emitter E is determined by the computing unit 7, in particular by means of a least-mean-square estimator (LMSE).

Subsequently, at least one further iteration is performed in which the illumination pattern is centered on the position of the emitter E determined in the previous iteration step. In particular, the parameters of the illumination sequence may be adjusted between iterations, e.g., by reducing the diameter of the illumination pattern and/or increasing the overall intensity of the illumination light.

For example, an uncalibrated position estimator may be a vector sum of the form

$$u ( {p}_{j} , {b}_{j} ) = \frac{{\sum }_{j = 1}^{m} {p}_{j} {b}_{j}}{{\sum }_{j = 1}^{m} {p}_{j}}$$

wherein pⱼ denotes the number of detected photons for illumination position j, wherein bⱼ is a vector denoting the position of the local minimum of the intensity distribution of the illumination light B at the illumination position j, and wherein m is equal to the total number of illumination positions in an illumination pattern.

For example, the estimator may be calibrated as follows to account for the influence of the actual emitter position on the estimator when determining the position:

r(pⱼ)=c(L,w)·u(pⱼ,bⱼ)

Here, c(L,w) denotes a correction factor that may depend in particular on the half-width of the intensity distribution of the illumination light B and on the diameter of the illumination pattern and may be obtained, for example, from a Montecarlo simulation.

The factor c(L,w) may also be replaced by a correction polynomial, e.g. of the form Pₖ(|u|²) where the correction polynomial is determined specifically for the respective iteration.

The background correction according to the present disclosure may be performed in particular by subtracting a value representing the background, e.g., an expected value for the background, from the sum Σⱼ₌₁^{m}pⱼ in the denominator of the above vector sum used as estimator, before the position of the emitter is determined. In particular, this is possible if the illumination pattern used for position determination does not comprise an illumination position at the center of the illumination pattern and the illumination positions of the illumination pattern are symmetrically arranged around the center. In this case, the proportions of the background on the summands in the numerator of the vector sum balance each other out—the background only affects the denominator of the estimator.

If inhomogeneously distributed background is corrected with the method according to the present disclosure by analyzing a distribution of light emissions on several detector elements 8,9 in the detection plane 10, in particular for each illumination position (each position of the local minimum of the intensity distribution), i.e., each illumination step, a separate value representing the background can be determined. In this case, it may also be necessary to adjust the terms Pⱼbⱼ in the numerator of the position estimator have to be corrected. For this purpose, for example, the value representing the background may be subtracted in each case from the value pⱼ (the photons detected for this illumination position). If the values pⱼ are corrected for each illumination position, the global correction of the denominator of the position estimator known from the prior art can then be omitted, since the values already corrected for background are then summed up in the denominator. Alternatively, the background correction can be included in the correction factor of the position estimator in the case of locally inhomogeneous background, wherein the effect of the background on the correction factor may be determined, e.g., in a simulation.

For example, to obtain a value representing the background, a histogram may be created from the detected light associated with the background (e.g., the light detected by the second detector elements 9 or a weighted sum of the light detected by the first detector elements 8 and the second detector elements 9), and the histogram may be evaluated to determine the value representing the background. To obtain the histogram, the numbers of background photons or background light intensities obtained in different, in particular successive, measurements are counted and sorted into classes, and a frequency distribution is obtained therefrom. Here the term “histogram” is understood both in the sense of the frequency distribution itself and in the sense of a graphical representation of this frequency distribution.

The expected value may then be determined, for example, from the maximum of the histogram and with the help of a peak detection algorithm.

In particular, in an iterative MINFLUX process, the histogram is iteration specific.

If the method according to the disclosure is performed in parallel with a MINFLUX measurement, the histogram may be a running histogram, i.e. a histogram with a fixed number of entries which is continuously changed according to the first-in-first-out principle, wherein, in particular, when the maximum number of entries is reached, the newest entry is included in the histogram and the oldest entry is deleted.

Instead of evaluating, as in the prior art, only sets of illumination positions/illumination steps where no emission of the emitter is detected, in particular deciding whether no emission of the emitter is detected by comparing the sum of photon numbers with a limit value derived from a currently estimated background, with the method according to the disclosure the background can be carried out in parallel with the MINFLUX measurement, for example by assigning groups of detector elements to the background or to the signal or by forming a weighted sum of the light intensities/photons detected Zo with several groups of detector elements or by continuously determining a value representing the background from the distribution of the light intensities/photons on the detector elements of an array detector.

### LIST OF REFERENCE SIGNS

1 Light microscope
2 Sample
3 Light source
4 Light modulator
Control unit
6 Detector
6a First detector
6b Second detector
7 Computing unit
8 First detector element
9 Second detector element
Detection plane
11 First partial area
12 Second partial area
13 Pinhole
13a First pinhole
13b Second pinhole
14 Reflective surface
15 Objective lens
16 First beam displacement device
17 Second beam displacement device
18 First beam splitter
19 Second beam splitter
20 First lens
21 Second lens
22 Third lens
B Illumination light
E Emitter
H Background
L Light emissions

1. A method for localizing or tracking emitters in a sample, comprising the steps of
performing an illumination sequence with a plurality of illumination steps, wherein the sample is illuminated in the illumination steps in each case with an intensity distribution of an illumination light comprising a local minimum, such that illumination positions in the sample are illuminated with different light intensities of the illumination light in the illumination steps, wherein the illumination light induces or modulates light emissions of the emitters, and wherein the local minimum of the intensity distribution is positioned in a region around a presumed position of an emitter in the sample in the illumination steps,
detecting light emissions of the emitter for the respective illumination steps,
determining the position of the emitter in the sample from the light emissions detected for the respective illumination steps,
wherein light emanating from the sample is detected with a plurality of detector elements, the detector elements comprising respective active areas whose projections into a focal plane in the sample are not congruent, wherein a background is estimated based on the light detected with the plurality of detector elements, and wherein, in determining the position of the emitter or for the determined position of the emitter, a background correction is performed based on the estimated background.

2. The method according to claim 1, wherein the plurality of detector elements comprise at least one first detector element and at least one second detector element, wherein a value representing the light emissions of the emitter is determined based on the light detected with the at least one first detector element, and wherein a value representing the background is determined based on the light detected with the at least one second detector element.

3. The method according to claim 2, wherein a plurality of second detector elements are provided.

4. The method according to claim 3, wherein a plurality of first detector elements are also provided.

5. The method according to claim 1, wherein a location-dependent background light distribution is determined from the light detected by the plurality of detector elements, wherein the background correction is performed depending on the respective position of the minimum of the intensity distribution by means of respective associated values of the background light distribution.

6. The method according to claim 1, wherein respective values representing the background are determined for the illumination steps based on the detected background light, wherein the background correction is carried out by means of the values representing the background.

7. The method according to claim 2, wherein the plurality of detector elements are arranged in a detection plane.

8. The method according to claim 7, wherein the at least one first detector element covers a first contiguous partial area of the detection plane, wherein the second detector elements cover a second contiguous partial area of the detection plane.

9. The method according to claim 8, wherein the second partial area encloses the first partial area.

10. The method according to claim 9, wherein the first partial area covers a central circular area of the detection plane.

11. The method according to claim 10, wherein the second partial area covers an annular area of the detection plane arranged around the central circular area.

12. The method according to claim 10, wherein the first partial area or the central circular area has an extent of 0.5 Airy Units to 1.0 Airy Units.

13. The method according to claim 2, wherein light emanating from the sample passes through a pinhole to the at least one first detector element, wherein the pinhole comprises a reflective surface, and wherein the at least one second detector element is arranged on a side of the pinhole opposite the at least one first detector element so that light reflected from the reflecting surface is detected by the at least one second detector element.

14. The method according to claim 13, wherein the reflective surface is arranged at an angle of less than 90° to an optical axis along which the light emanating from the sample propagates.

15. The method according to claim 13, wherein the pinhole comprises a central light-transmitting region with an extent of 0.5 Airy Units to 1.0 Airy Units.

16. The method according to claim 2, wherein a weighted sum or difference is formed between intensities or photon numbers of the light detected by the at least one first detector element and the light detected by the at least one second detector element, wherein the position of the emitter and/or the value representing the background is determined based on the weighted sum or difference.

17. The method according to claim 1, wherein the background is estimated in parallel with the determination of the position of the emitter.

18. The method according to claim 1, wherein light is detected with the plurality of detector elements before performing the illumination sequence, wherein the background is estimated from the detected light.

19. A light microscope for localizing or tracking emitters in a sample, comprising
a light source configured to generate illumination light that induces or modulates light emissions from an emitter in a sample,
a light modulator configured to generate an intensity distribution of the illumination light with a local minimum in the sample,
a control unit which is configured to perform an illumination sequence with a plurality of illumination steps, the control unit being configured to control the light source and/or the light modulator in such a way that the sample is illuminated in each case with an intensity distribution of the illumination light comprising a local minimum in the illumination steps, such that illumination positions in the sample are illuminated with different light intensities of the illumination light in the illumination steps, and such that the local minimum of the intensity distribution is positioned in a region around a presumed position of an emitter in the sample in the illumination steps,
at least one detector configured to detect light emanating from the sample for the illumination steps,
a computing unit which is configured to determine the position of the emitter in the sample from the light emissions detected for the respective illumination steps,
wherein the at least one detector comprises a plurality of detector elements, the detector elements comprising respective active areas whose projections into a focal plane in the sample are not congruent, the computing unit being configured to estimate a background based on the light detected by the plurality of detector elements, and perform a background correction based on the estimated background in determining the position of the emitter or for the determined position of the emitter.

20. A non-transitory computer readable medium for storing computer instructions for localizing or tracking emitters in a sample that, when executed by one or more processors associated with a light microscope causes the one or more processors to perform a method according to claim 1.
